(19) United States
(12) Patent Application Publication
(10) Pub. No.: US 2018/0240445 A1
(43) Pub. Date: Aug. 23, 2018

(54) DRUM HOOP AND A DRUM HAVING THE SAME

(71) Applicant: Kuo-Chang CHEN, Taichung City (TW)

(72) Inventor: Kuo-Chang CHEN, Taichung City (TW)

(21) Appl. No.: 15/438,198

(22) Filed: Feb. 21, 2017

(51) Int. Cl. G10D 13/02

(52) U.S. Cl. CPC G10D 13/023; G10D 13/025

(57) ABSTRACT

A drum hoop is provided and is made by rolling a metal board, the drum hoop includes an abutting section, a slanting section and a trimming section which have a same thickness, the abutting section is for abutting against and fixing a drumhead unit, the slating section is tilted relative to the abutting section, and the trimming section and the abutting section are respectively located by two sides of the slanting section. A drum using the above-mentioned drum hoop is further provided.

### BACKGROUND OF THE INVENTION

### Field of the Invention

The present invention relates to a drum hoop and a drum having the same.

### Description of the Prior Art

A snare drum is an important component of a drum set, and the snare drum is often used since its timbre has a preferable penetration and power. Regarding a structure of the snare drum, a drumhead unit is sandwiched and positioned between a drum shell and a drum hoop, and the sound of the snare drum is changed through controlling a tightness of the drum hoop pressing the drumhead unit to adjust a tension of the drumhead unit. In addition, the drum hoop can be categorized into die cast hoops and flange hoops according to the manufacturing method of the drum hoop.

Die cast hoops are manufactured by melting a metal into liquid and pouring the melted metal into a mold, and the snare drum which is assembled with the die cast hoops have strong and solid timbre. This type of drum hoops are disclosed in U.S. Pat. No. 6,365,811, U.S. Pat. No. 8,859,869 and US749160. However, the manufacturing requirement of this type of drum hoops is strict (a manufacturer may manufacture the drum hoops with many voids to decrease cost; however, with voids in the drum hoops, the structural strength may become weaker). In addition, considering weight, the drum hoops are made through casting mold with lighter aluminum or ally (for example, Zn—Cr alloy or aluminum alloy), and the cost and price are higher.

Flange hoops are drum hoops which are made by rolling a metal sheet (for example, copper or iron) and not die cast hoops, and this type of drum hoops can be divided into two-flange and three-flange structures as disclosed in U.S. Pat. No. 6,291,752, U.S. Pat. No. 8,563,841, U.S. Pat. No. 7,786,363, U.S. Pat. No. 8,367,917 and U.S. Pat. No. 9,336,758. Compared with the die cast hoops, the flange hoops are easier to be manufactured and have lower cost and greater density and strength. However, compared with the die cast hoops, the snare drum which uses the drum hoops with the flange hoops produces noise more easily, and the timbre is less penetrating and direct.

The present invention has arisen to mitigate and/or obviate the afore-described disadvantages.

### SUMMARY OF THE INVENTION

The major object of the present invention is to provide a drum hoop and a drum having the same, which provide different modes for a user to use according to various requirements so as to eliminate resonant noises and allow a timbre to transmit directly. In addition, when drumsticks collide with the drum hoop, the drumsticks can be prevented from being damaged to ensure that the drumsticks have preferable service life.

To achieve the above and other objects, a drum hoop is provided and is made by rolling a metal board, the drum hoop includes an abutting section, a slanting section and a trimming section which have a same thickness, the abutting section is for abutting against and fixing a drumhead unit, the slating section is tilted relative to the abutting section, the slanting section and the abutting section have an included angle therebetween, the included angle is greater than 90 degrees, and the trimming section and the abutting section are respectively located by two sides of the slanting section.

To achieve the above and other objects, a drum is further provided, including the drum hoop mentioned above and further including a drum shell, at least one drumhead unit and a plurality of tension-adjusting units. The drum shell defines a resonant space, and the drum shell has at least one opening which communicates with the resonant space. At least one drumhead unit respectively covers the at least one opening, a number of the at least one drumhead unit, a number of the at least one opening and a number of the at least one drum hoop correspond to one another, and the drumhead unit is sandwiched between the drum shell and the drum hoop. A plurality of tension-adjusting units are respectively connected to one said drum hoop and the drum shell, and the plurality of tension-adjusting units are for adjusting a force of one said drum hoop abutting against one said drumhead unit.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first embodiment of the present invention;

FIG. 2 is a partially-enlarged breakdown view of FIG. 1;

FIG. 3 is a breakdown view of FIG. 1;

FIG. 4 is a partial cross-sectional view of FIG. 1;

FIG. 5 is a partial cross-sectional view of a second embodiment of the present invention; and

FIG. 6 is a partial cross-sectional view of a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

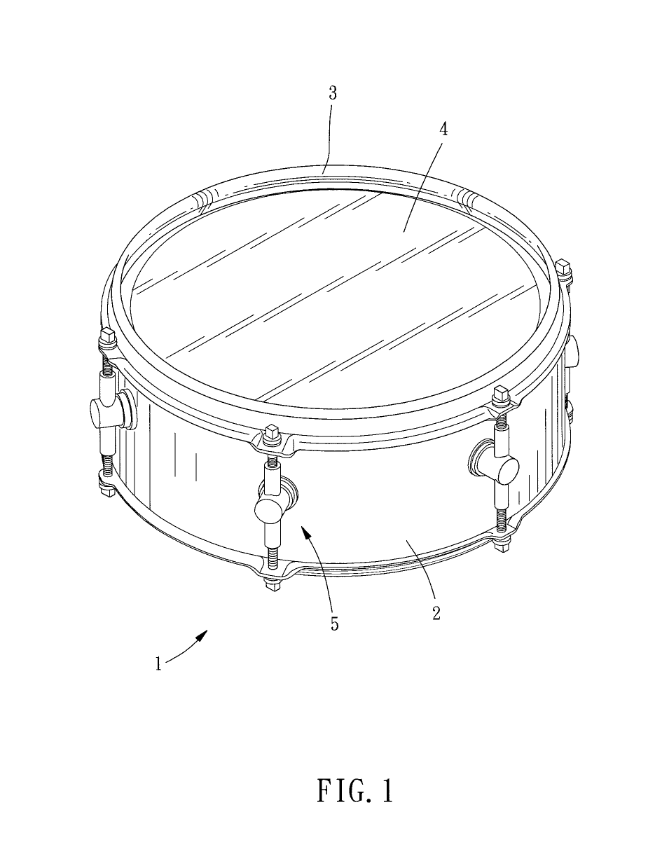

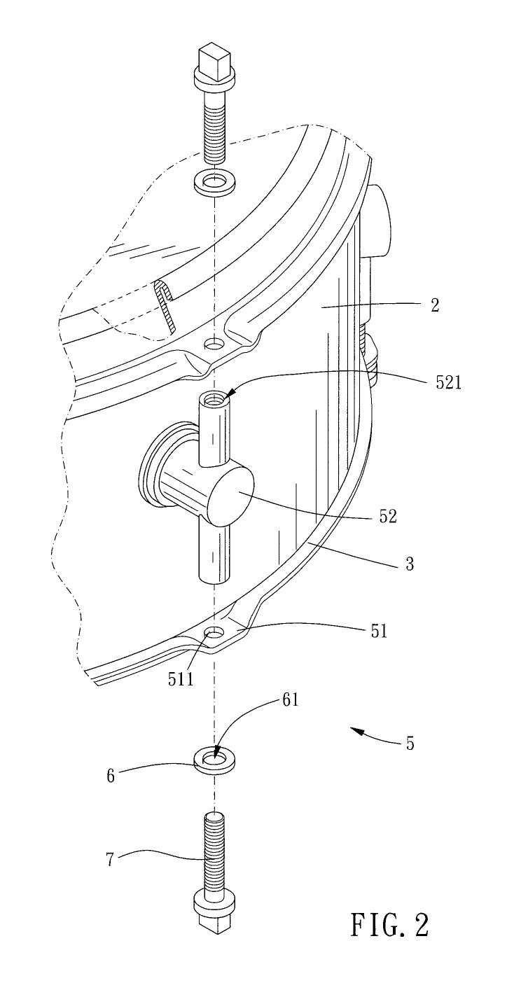

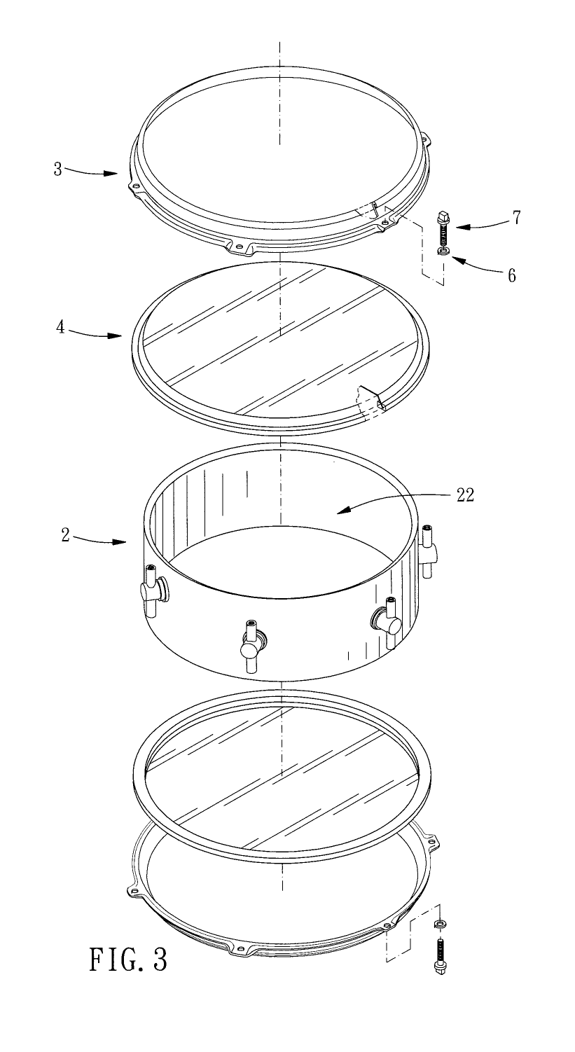

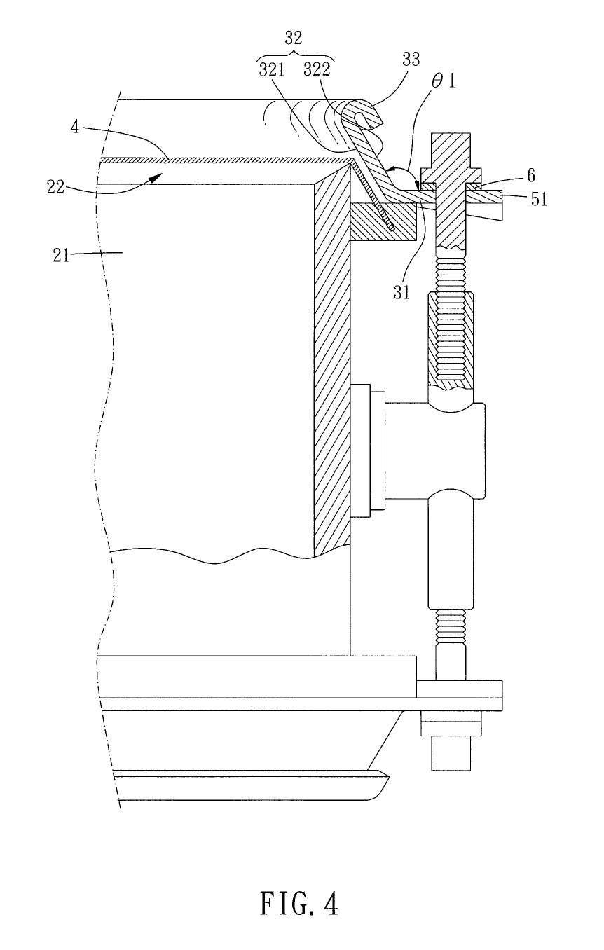

Please refer to FIGS. 1 to 4 for a first embodiment of the present invention. A drum hoop 3 is made by rolling a metal board, the drum hoop 3 includes an abutting section 31, a slanting section 32 and a trimming section 33 which have a same thickness, the abutting section 31 is for abutting against and fixing a drumhead unit 4, the slating section 32 is tilted relative to the abutting section 31, the slanting section 32 and the abutting section 31 have an included angle θ1 therebetween, the included angle θ1 is greater than 90 degrees, and the trimming section 33 and the abutting section 31 are respectively located by two sides of the slanting section 32.

Specifically, the drum hoop 3 is tapered toward a direction away from the drumhead unit 4 so that a timbre is more concentrated and reflected more intensely. During a process of reflection, a part of the noises of the timbre are absorbed by the drum hoop 3 so that the timbre is clearer. In addition, since the timbre is reflected in many times intensely, a time of reverberation increases so that the timbre provides different layers, and the timbre is more stereoscopic and has a sound mixing effect. Preferably, the included angle θ1 is 110 degrees to 150 degrees, after being tested, in the first embodiment, when the included angle θ1 is 120 degrees, the drumming effect is more preferable.

More specifically, a drumstick hits the drumhead unit 4 in a skew angle, and a part of the drumstick hits the slanting section 32, so the slanting section 32 can cooperate with the drumstick which hits the drumhead unit 4 in the skew angle so that the drumstick can contact the drumhead unit 4 in a greater area; therefore, a hitting force can be decentralized and transmitted so that a stress is not easily centralized to cause the drum hoop 3 to deform. It is understandable that the slanting section 32 has a first wall portion 321 and a second wall portion 322 opposite to each other, the first wall portion 321 faces the drumhead unit 4, the second wall portion 322 faces away from the drumhead unit 4, and preferably, the trimming section 33 bends toward a side of the second wall portion 322. When the drumstick hits the drum hoop 3, the trimming section 33 which is bent and curved can make the drumstick uneasy to be broken so as to prolong a service life of the drumstick.

To be more specific on the drum hoop 3 of the first embodiment, a part of the trimming section 33 is substantially parallel to the second wall portion 322, the slanting section 32 is substantially parallel to a part of the drumhead of the drumhead unit 4, and the abutting section 31 is greater than the slanting section 32 in length. More specifically, the trimming section 33 and the slanting section 32 forms a substantially η shape, and a thickness of the drum hoop 3 is substantially 2.3 mm.

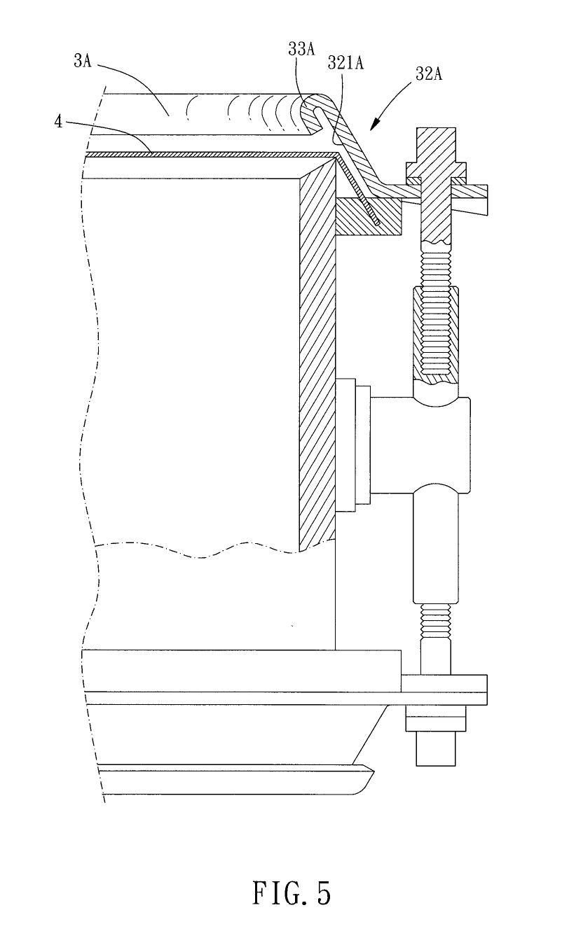

In addition, a bending direction of the trimming section 33 is not restricted. Please refer to a second embodiment of FIG. 5 for a drum hoop 3A, a trimming section 33A bends toward a side of a first wall portion 321A. Therefore, aside from the effects mentioned in the first embodiment, the trimming section 33A and the slanting section 32A further define a space, and the space have the functions of absorbing surrounding noises when the drumhead unit 4 vibrates.

Please further refer to FIGS. 1 to 4. A drum 1 is further provided, including the drum hoop 3 mentioned above and further including a drum shell 2, at least one drumhead unit 4 and a plurality of tension-adjusting units 5.

The drum shell 2 defines a resonant space 21, the drum shell 2 has at least one opening 22 which communicates with the resonant space 21. The at least one drumhead unit 4 respectively covers the at least one opening 22, a number of the at least one drumhead unit 4, a number of the at least one opening 22 and a number of the at least one drum hoop 3 correspond to one another, and the drumhead unit 4 is sandwiched between the drum shell 2 and the drum hoop 3. The plurality of tension-adjusting units 5 are respectively connected to one said drum hoop 3 and the drum shell 2, and the plurality of tension-adjusting units 5 are for adjusting a force of one said drum hoop 3 abutting against one said drumhead unit 4. In the first embodiment, a number of the at least one opening 22, a number of the at least one drumhead unit 4 and a number of the at least one drum hoop 3 are respectively two.

More specifically, each said tension-adjusting unit 5 includes a first connecting portion 51, a second connecting portion 52, a fixing member 6 and a screwing member 7 (for example, a bolt), the first connecting member 51 is disposed on the drum hoop 3 and has a first through hole 511 along an opening direction of the opening 22, the second connecting portion 52 is disposed on the drum shell 2 and has a connecting hole 521 along the opening direction, the fixing member 6 is disposed through the first through hole 511 or the connecting hole 521 and has a second through hole 61 along the opening direction, and the screwing member 7 is disposed through the first and second through holes 511, 61 and screwed with the connecting hole 521.

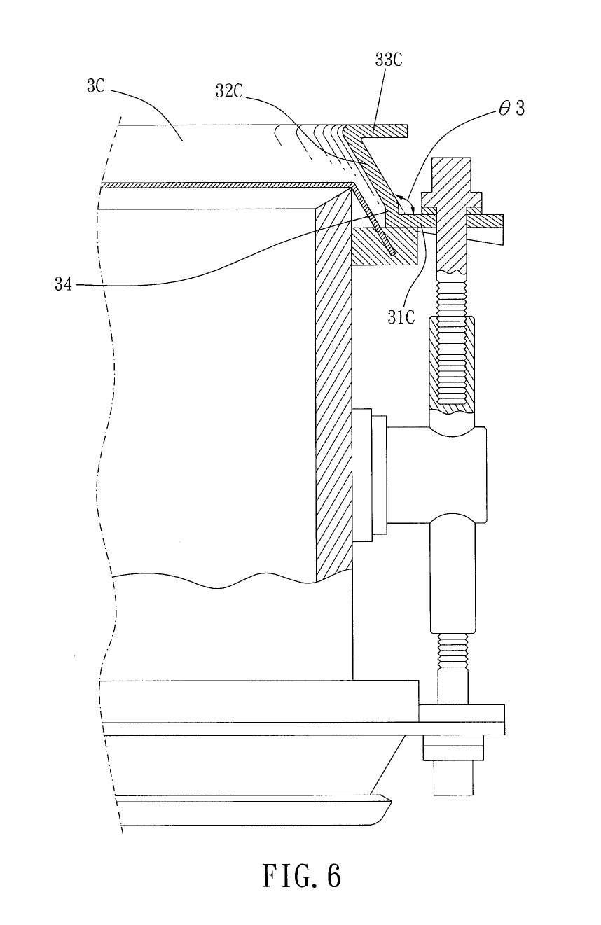

In addition, in the first embodiment of FIGS. 1 to 4, the slanting section 32 extends linearly and is directly connected to the abutting section 31, but the slanting section 32 is not limited thereto. Please refer to a third embodiment of FIG. 6 for a drum hoop 3C. The drum hoop 3C further includes a connecting section 34, the connecting section 34 is connected to and between an abutting section 31C and a slanting section 32C, the connecting section 34 is perpendicular to the abutting section 31C, and the trimming section 33C is parallel to the abutting section 31C. In other words, the slating section 32C may be indirectly connected to the abutting section 31C as long as the slanting section 32C and the abutting section 31C have an included angle θ3 therebetween (including the situation that extension lines of the slanting section 32C and the abutting section 31C intersect with each other to form the included angle θ3). It is understandable that a structure of the connecting section 34 may be applied to the afore-mentioned first and second embodiments.

Given the above, the drum hoop and the drum having the same provide different modes for a user to use according to various requirements so as to eliminate resonant noises and to disperse sound waves uniformly when drumming Specifically, the slanting section is designed to effectively disperse and transmit a hitting force of the drumstick so as to prevent the drum hoop from deforming due to stress concentration and further to ensure that the drum hoop has a preferable service life. With the trimming section which has a curved structure, when the drumstick hits the drum hoop, the drumstick will not be easily damaged or broken. In addition, when the screwing member is rotated, an outer circumferential wall of the screwing member circumferentially interferes with the fixing member so as to stably position the screwing member.

While we have shown and described various embodiments in accordance with the present invention, it should be clear to those skilled in the art that further embodiments may be made without departing from the scope of the present invention.

1. A drum hoop, which is made by rolling a metal board, the drum hoop including an abutting section, a slanting section and a trimming section which have a same thickness, the abutting section being for abutting against and fixing a drumhead unit, the abutting section having a fixing portion for a fixing element to connect wherein the fixing element connects the fixing portion and a drum shell, the slanting section tilted relative to the abutting section, the slanting section and the abutting portion having an included angle therebetween, wherein the included angle is ranged between 110 to 150 degrees, and the trimming section and the abutting section are respectively located at a top and a bottom of the slanting section;
wherein a top of the trimming section defines an imaginary plane, the fixing portion is parallel to the imaginary plane, the slanting section is non-perpendicular to and inclined with respect to the imaginary plane.

2. (canceled)

3. The drum hoop of claim 1, wherein the slanting section has a first wall portion and a second wall portion opposite to each other, the first wall portion faces the drumhead unit, the second wall portion faces away from the drumhead unit, and the trimming section bends toward a side of the second wall portion.

4. The drum hoop of claim 3, wherein a part of the trimming section is substantially parallel to the second wall portion.

5. The drum hoop of claim 1, wherein the slanting section has a first wall portion and a second wall portion opposite to each other, the first wall portion faces the drumhead unit, the second wall portion faces away from the drumhead unit, and the trimming section bends toward a side of the first wall portion.

6. The drum hoop of claim 1, further including a connecting section, the connecting section connected to and between the abutting section and the slanting section, the connecting section perpendicular to the abutting section.

7. The drum hoop of claim 4, wherein the included angle is 120 degrees; the trimming section and the slating section forms a substantially η shape, and a thickness of the drum hoop is substantially 2.3 mm.

8. A drum, including at least one drum hoop of claim 1, further including:
a drum shell, defining a resonant space, the drum shell having at least one opening which communicates with the resonant space;
at least one drumhead unit, respectively covering the at least one opening, a number of the at least one drumhead unit, a number of the at least one opening and a number of the at least one drum hoop corresponding to one another, the at least one drumhead unit being sandwiched between the drum shell and the at least one drum hoop;
a plurality of tension-adjusting units, respectively connected to one of the at least one drum hoop and the drum shell, the plurality of tension-adjusting units for adjusting a force of one said drum hoop abutting against one of the at least one drumhead unit.

9. The drum of claim 8, wherein each said tension-adjusting unit includes a first connecting portion, a second connecting portion, a fixing member and a screwing member, the first connecting member is disposed on the at least one drum hoop and has a first through hole along an opening direction of the at least one opening, the second connecting portion is disposed on the drum shell and has a connecting hole along the opening direction, the fixing member is disposed through the first through hole or the connecting hole and has a second through hole along the opening direction, the screwing member is disposed through the first and second through holes and screwed with the connecting hole; wherein when the screwing member is rotated, an outer circumferential wall of the screwing member circumferentially interferes with the fixing member.

10. The drum of claim 9, wherein a number of the at least one opening, a number of the at least one drumhead unit and a number of the at least one drum hoop are respectively two; and the slanting section is substantially parallel to a part of the at least one drumhead unit.
